(19) United States
(12) Patent Application Publication
(10) Pub. No.: US 2026/0284538 A1
(43) Pub. Date: Sep. 24, 2026

(54) METHOD AND SYSTEM FOR PROTECTING A USER OF ONE OR MORE SOCIAL NETWORKS OR VIDEO GAMES AGAINST RISKS OF CYBERBULLYING

(71) Applicant: SafeBear, Paris (FR)

(72) Inventors: Jérémy Guillon, Colombes (FR); Christian Guillon, Quincy-Sous-Sénart (FR)

(21) Appl. No.: 19/475,337

(22) PCT Filed: Apr. 26, 2024
(86) PCT No.: PCT/EP2024/061627

§ 371 Date: Oct. 14, 2025

(30) Foreign Application Priority Data
Apr. 28, 2023 (FR) 2304313

(51) Int. Cl. A63F 13/75; A63F 13/87

(52) U.S. Cl. CPC A63F 13/75; A63F 13/87

(57) ABSTRACT

A method for protecting a user of one or more social networks or video games, using a connected device, against risks of cyberbullying, includes carrying out semantic and contextual analysis on accessed or received digital content, employing artificial-intelligence techniques implementing a plurality of brains each dedicated to a particular cyberbullying theme and operating simultaneously, and carrying out processing of the results of the semantic and contextual analysis in order to detect a cyberbullying situation or a toxicity of all or part of the content. If a cyberbullying situation or a toxicity of digital content is detected, the protection method writes, to a blockchain on the Web3, a set of data describing this cyberbullying, and masks the display of the toxic digital content on the screen of the connected device.

### CROSS-REFERENCE TO RELATED APPLICATIONS

This application is a national phase entry under 35 U.S.C. § 371 of International Patent Application PCT/EP2024/061627, filed Apr. 26, 2024, designating the United States of America and published as International Patent Publication WO 2024/223873 A1 on Oct. 31, 2024, which claims the benefit under Article 8 of the Patent Cooperation Treaty of French Patent Application Serial No. FR2304313, filed Apr. 28, 2023.

### TECHNICAL FIELD

The present disclosure relates to a method for protecting a user of one or more social networks or video games against risks of cyberbullying and toxic content. It also relates to a processing system employing this method.

The field of the present disclosure is more particularly that of preventing cyberbullying and online toxicity on social networks.

### BACKGROUND

Since the emergence and widespread deployment of social networks worldwide, there has been a growing number of cases of cyberbullying and online toxicity, and parents of children with access to these social networks are powerless against the serious risks their children may face.

Software tools already exist to detect toxic or cyberbullying messages in the flow of information passing through messaging systems and social networks.

U.S. Pat. No. 11,138,237 B2, titled “Social Media Toxicity analysis,” discloses a method for analyzing toxicity of social media content, including constructing a class model that is representative of a type and level of toxicity associated with the content. A first social media message is analyzed, using a processor and memory, to calculate a first toxicity score associated with the first social media message and assign the first social media message to a first class of the class model. A second social media message is analyzed, using a processor and memory, to calculate a second toxicity score associated with the second social media message and assign the second social media message to a second class of the class model. A toxicity trend is predicted based on the first toxicity score, the first class, the second toxicity score and the second class. In response to the predicted increase in the toxicity trend, a corrective measure is applied to reduce the toxicity trend.

U.S. Pat. No. 10,915,789 B2 discloses a method and device for detecting offensive content on a portable electronic device, by monitoring communications sent, received or stored on the portable electronic device, and wherein monitoring comprises collecting content data, classifying content data by calculating an alert score for content data wherein an alert score corresponds to an offensive content detected, and sending an alert notification to a second portable electronic device to alert the detection of offensive content on the first portable electronic device.

U.S. Patent Application Publication No. 2019/0266242 A1 discloses a method for mitigating cyberbullying by intercepting and accurately analyzing the sentiment of social media messages before presenting them to the intended recipient device. Based on the sentiment of the messages and the sender category, the abusive messages may be sent to an administrator for review and to take appropriate action. As a result, such messages may be blocked from the intended recipient device. The system may analyze the sentiment of the messages using a machine learning approach, for example, employing a Naive Bayes algorithm. An inference model may be generated via machine learning. The inference model may produce a metric that is used when evaluating the message sentiment.

U.S. Patent Application Publication No. 2021/0042830 A1 discloses a digital multimedia system that uses a decentralized communication system to transfer digital data. In some embodiments, the digital data comprises digital property, currency and instructions for executing financial transactions. In some embodiments, the digital multimedia system controls the storage and flow of digital data through specified nodes located in specified jurisdictions.

U.S. Patent Application Publication No. 2018/349502 A1 discloses a method and system for filtering content from a graphical display of a computing device, which content may have an object associated with content identifiers. This method comprises determining, by the computing device and based on an indication of selected filter criteria, of a respective weighted probability for the object, and determining a graphical element for an application based on the weighted probability.

International Patent Application Publication No. WO2015/095597 A1 discloses a method and system allowing parents to view and track smartphone activities of their children that may comprise one or more child software modules. The module, which can be installed on each child's smartphone, can access and extract data about several of the smartphone's other software applications, including at least two of the following applications: a texting application, a social media application, an image application that facilitates the transmission or reception of images, and a web browser application.

U.S. Patent Application Publication No. 2015/095014 A1 discloses a method for content selection and assessment. A content classification platform processes content directed to or originating from a user to determine one or more elements in the content. The content assessment platform calculates a content assessment for the content by comparing the one or more elements against at least one user-configurable dictionary, and then selects an operation to process the content based on the content assessment.

International Patent Application Publication No. WO2022/055546 A1 discloses a method, system and product for filtering out unwanted social multimedia content in real time. The system comprises sets of machine-learning classifiers to filter out unwanted content on several media. Classifiers are trained with labeled data. After being trained, the models filter the incoming data in real time, either on a server or on a mobile device.

However, it must be noted that the tools currently available are not effective and user-friendly for users of social networks and parents of minors accessing these networks.

The present disclosure aims to remedy these disadvantages and limitations by proposing a new method for online processing of cyberbullying or toxic content that is more efficient and user-friendly than existing tools.

Brain is understood herein as a computer model, based on the simulation of the activity of populations of neurons, which possesses or develops cognitive faculties similar to biological brains.

Blockchain is understood as a register, a large database that has the particular feature of being shared simultaneously with all its users, all of whom are also holders of this register, and all of whom also have the ability to write data to it, according to specific rules set by a computer protocol that is highly secure by virtue of cryptography, referring to the definition given in the “Log of the joint information mission on blockchain and its uses: a sovereignty issue.”

[https:/www2.assemblee-nationale.fr/static/15/commissions/CFinances/blockchain-synthese.pdf?v=1692355067].

### BRIEF SUMMARY

This objective is achieved with a method for protecting a user of one or more social networks or video games against risks of cyberbullying, this user having a device connected to a communication network to access digital content from the one or more social networks or video games or to receive digital content from one or more other users of the one or more social networks or video games, comprising:
carrying out semantic and contextual analysis on the accessed or received digital content, employing artificial-intelligence techniques,
carrying out processing of the results of the semantic and contextual analysis in order to detect a cyberbullying situation or a toxicity of all or part of the content, employing a database of predetermined situations,
if a cyberbullying situation or a toxicity of digital content is detected, masking the display of the toxic digital content on the screen of the connected device,
wherein the method is implemented in a dedicated server suitable for being connected, via the communication network, to the social networks or video games,
and in that the method further comprises, if a situation of cyberbullying or toxicity of digital content is detected, writing to a blockchain a set of data describing this cyberbullying, and wherein the semantic and contextual analysis implements a plurality of brains, each dedicated to a particular cyberbullying theme and operating simultaneously, each of the brains being intended to detect, after analysis, a word, a transcription of a voice message, an expression or an Emoji belonging to the theme associated therewith.

The data describing cyberbullying or a toxicity of content can be output in the form of a reporting log.

The protection method according to the present disclosure can further comprise a prior check of the identity of the user to be protected, employing encryption of the identity data entered by this user from the connected device, and employing decentralized software tools on the Web3.

The protection method according to the present disclosure can further comprise a step for accessing, from a second connected device, digital content received and detected as constituting cyberbullying or toxic content on a first connected device, as well as a step for entering from the connected device a mention of one or more social networks or video game networks on which protection is sought.

When the protection method according to the present disclosure is applied to participation in an online video game, the semantic and contextual analysis steps are further configured to detect a toxicity situation in this video game.

In accordance with another aspect of the present disclosure, a system is proposed for protecting a user of one or more social networks or video games against risks of cyberbullying, this user having a device connected to a communication network to access digital content from the one or more social networks or video games or to receive digital content from one or more other users of the one or more social networks or video games, employing the protection method according to the present disclosure, this system comprising:
means for carrying out semantic and contextual analysis on the accessed or received digital content, employing artificial-intelligence techniques,
means for processing the results of semantic and contextual analysis in order to detect a cyberbullying situation or a toxicity of all or part of the content, employing a database of predetermined situations,
if a cyberbullying situation or a toxicity of digital content is detected, means for masking the display of a toxic digital or cyberbullying content on the screen of the connected device,
wherein the system is implemented in a dedicated server suitable for being connected, via the communication network, to the video game social networks, and wherein the system further comprises means for writing to a blockchain a set of data describing this cyberbullying, and wherein the means for carrying out semantic and contextual analysis comprise a plurality of brains each dedicated to a particular cyberbullying theme and operating simultaneously, each of the brains being intended to detect, after analysis, a word, a transcription of a voice message, an expression or an Emoji belonging to the theme associated therewith.

The protection system according to the present disclosure can advantageously be implemented within a dedicated server communicating via one or more communication networks, on the one hand, with one or more platforms operating social network services and, on the other hand, with a plurality of connected devices accessing these social network services and for which protection against cyberbullying is sought.

The system can also comprise means for sending a notification of detection of a cyberbullying situation to a dedicated platform.

The processing method according to the present disclosure is advantageously carried out in the form of an application to combat cyberbullying and online toxicity, which can be downloaded onto any medium (mobile/tablet/pc/console).

With the help of its Artificial Intelligence, the method masks the toxicity on social networks added by its users and the hate messages they may receive. It semantically and contextually analyzes conversations to obtain results that match the user's wishes.

If a user encounters real cyberbullying problems, the application implementing the method according to the present disclosure supports the user in their legal proceedings and certifies their data to establish a file for filing a complaint with the competent authorities. The application also helps the victim find an association specializing in the fight against online toxicity.

The application is also suitable for online gamers, for whom toxicity is a recurring problem, by integrating with the platforms on which they are connected, as well as with video games authorizing the solution to act.

The application also allows users and their designated guardians to be informed if they send inappropriate contextual elements that could be considered toxic by their receivers.

This application is built using software tools available in the AWS universe, according to the architecture below:

The processing method according to the present disclosure employs:
an application fully designed for deployment on the Web3, across multiple media and social networks,
an AI employing a plurality of brains each assigned to the detection of a particular typology of cyberbullying content, in contrast to the usual practice of using a single brain, and
assistance with the automatic output of reporting log and writing of all types of content reporting (image/text/video/file) to a blockchain.

### BRIEF DESCRIPTION OF THE DRAWINGS

FIG. 1 is a block diagram of an exemplary embodiment of a system for protecting against cyberbullying according to the present disclosure;

FIG. 2 exemplifies the main steps of an exemplary embodiment of the protection method according to the present disclosure;

FIG. 3 exemplifies an example of software architecture employed in a protection system according to the present disclosure;

FIG. 4 depicts an example of a user interface that provides a protected user with a summary of operations for detecting situations of cyberbullying and toxic content;

FIG. 5 depicts an example of a user interface that provides a supervisor user with a summary of operations for detecting situations of cyberbullying and toxic content to which one or more family members, especially minors, may have been exposed;

FIG. 6 depicts an example of a user interface that provides a protected user with blocking and reporting functions in response to the detection of cyberbullying or toxic content; and

FIG. 7 depicts an example of a user interface that provides a video game user with a dashboard of the detection operations carried out by the protection method according to the present disclosure.

### DETAILED DESCRIPTION

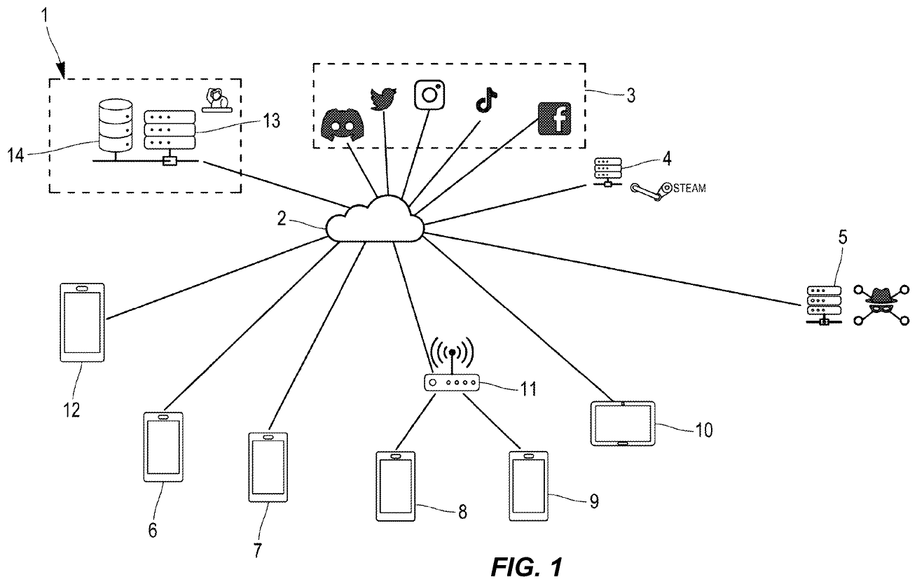

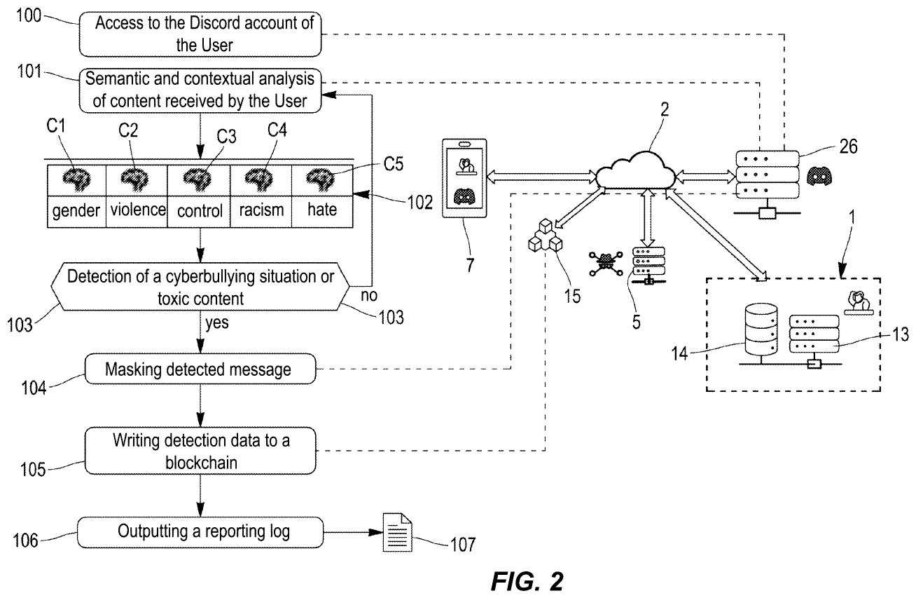

Referring to FIGS. 1 and 2, a system 1 for protecting against cyberbullying according to the present disclosure is employed in a server 13 to which a database 14 is associated, and is connected via a common network to a digital cloud 2 (usually referred to as the Cloud) linking a set of social network platforms 3 (or social media) including, for example, but not limited to, Discord®, Twitter®, Instagram®, TikTok® or Facebook®, and video game platforms 4 such as the platform Steam®.

The method for protecting against cyberbullying according to the present disclosure is used in a set of digital communication devices connected to the Cloud 2, such as smartphones 6-9, 12, or tablets 10 on which a dedicated application has been installed. Some of these smartphones 8, 9 can be connected to resources of the Cloud 2 via a router 11.

The mission of the system 1 for protecting against cyberbullying according to the present disclosure will be to protect users of smartphones or tablets 6-10 equipped with the protection application, against the malicious actions of people or organizations from servers 5 connected to the Cloud 2 and seeking to harm these users via one or more social networks or one or more video game platforms.

A description will now be given, still referring to FIG. 2, of an embodiment of the method for protecting against cyberbullying according to the present disclosure. It is assumed that a dedicated application has been downloaded by a user of a smartphone 7 from a protection server 1 implementing the protection method according to the present disclosure.

This application, which provides a graphical interface on the screen of the smartphone 7 of a user or on the screen of a smartphone 12 belonging to a parent or family member user of a minor user, requests an access 100 to the user's account on a social network, for example, the Discord network, from the server 26 managing this network.

Once the server 13 managing the protection method has obtained access to the Discord social network account of the protected user, a semantic and functional analysis 101 of the content received on this user account will be carried out, either permanently or periodically at a predetermined frequency. This analysis is carried out directly at the protection server, before the analyzed content can be viewed on the smartphone 7 of the user.

This analysis 101 employs a set of artificial brains C1, C2, C3, C4, C5, each assigned to a particular category of cyberbullying or toxicity.

Artificial brain is understood as a computer model, based on the simulation of the activity of populations of neurons, which possesses or develops cognitive faculties similar to biological brains.

If a malicious server 5 sends a cyberbullying content message or message with toxic content to the protected user, one of the brains C1-C5 will detect 103, after analysis, a word, a transcript of a voice message, an expression or an Emoji belonging to one of the categories associated with each of these brains.

The protection server 13 will then mask 104 the message detected as constituting cyberbullying or toxic content, so that this message or this content will not be accessed by the protected user on the screen of their smartphone 7.

This is followed by a step 105 of writing data describing this detection of cyberbullying or toxicity to a blockchain 15 that is accessible by the protection server 13 via the Cloud 2, and a step 106 of outputting a reporting log 107 intended to be transmitted to an administrative or official authority responsible for combating cyberbullying.

Detection data may include, for example, the content of the intercepted message, the date, time and origin (if technically possible) of this message.

In a configuration of the invention dedicated to protecting minor users under the supervision of a parent, several options for employing the protection method according to the present disclosure can be provided.

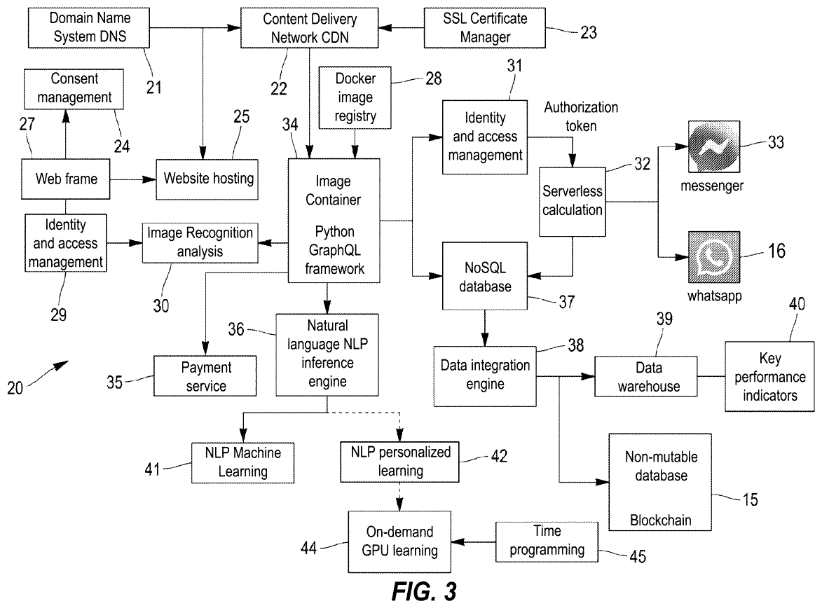

The protection method according to the present disclosure can be built from, but not limited to, a software architecture 20 such as that shown in FIG. 3. Several basic modules of this software architecture can be taken from the AWS (Amazon Web Services) software offering.

The software architecture 20 employs a domain name system DNS 21, associated with an SSL certificate management 23 and a content delivery network CDN 22 for managing and hosting 25 the website implementing the protection method according to the present disclosure.

This website is built on a Web Framework 27 driving a consent management module 24 and a personal identity and access management module 29.

The heart of the software architecture 20 comprises an image Container module 34, built, for example, from a GraphQL Framework in Python, which is fed by a Docker Image Registry 28.

This container 34 drives a payment service module 35, an image recognition module 30 controlled by the identity and personal access management module 29, a natural language processing (NLP) inference engine 36, a module 31 for managing identities and access to social networks that will be protected, and a NoSQL database 37.

The module 31 for managing identities and access to social networks controls, via authorization tokens, a serverless computing module 32 that directly addresses each of the social networks 16 (for example, WhatsApp), 33 (for example, Messenger) that are targeted by the protection method according to the present disclosure. It is understood that these social networks can include, but are not limited to, Discord, Twitter, Instagram, TikTok or Facebook, as exemplified in FIG. 1.

The natural language processing NLP inference engine 36 drives an NLP Machine Learning module 41, an NLP personalized learning module 42 that can address a GPU (Graphical Processing Unit) learning module 44 on demand, which can be activated by a time programming module 45.

The NoSQL database 37 feeds a data integration engine 38, which feeds a data warehouse 39 provided with a key performance indicator module 40, and a non-mutable database or a blockchain 15.

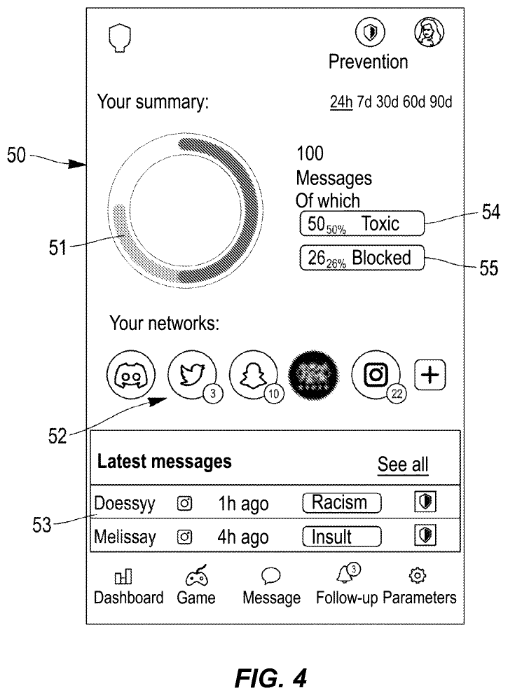

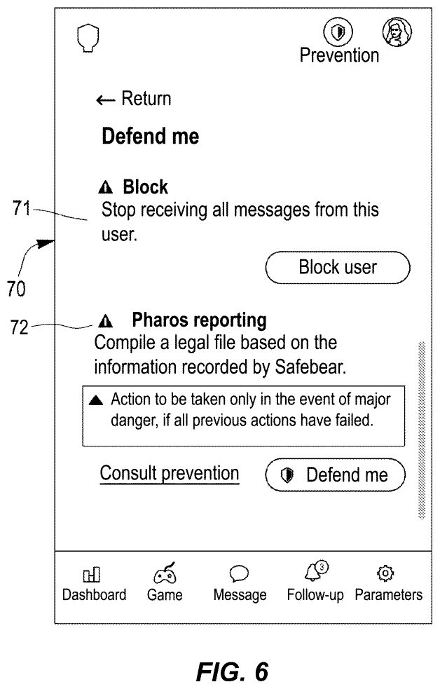

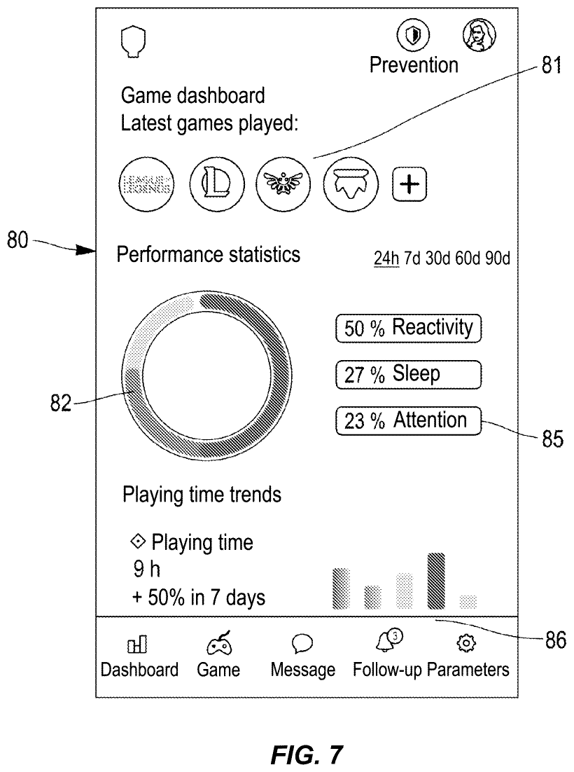

Referring to FIGS. 4 to 7, several practical examples of graphical user interfaces generated on the screen of protected users or a supervisor, by implementing the protection method according to the present disclosure, will now be described.

The user interface 50 represented by FIG. 4 corresponds to what a protected user will be able to view on the screen of their smartphone: it contains a graphic summary 51, for example, in circular form, illustrating the percentages of toxic messages 54 and blocked messages 55. The protected user can access summary data for each of the social networks 52 to which they are subscribed, and a list 53 of the latest blocked messages.

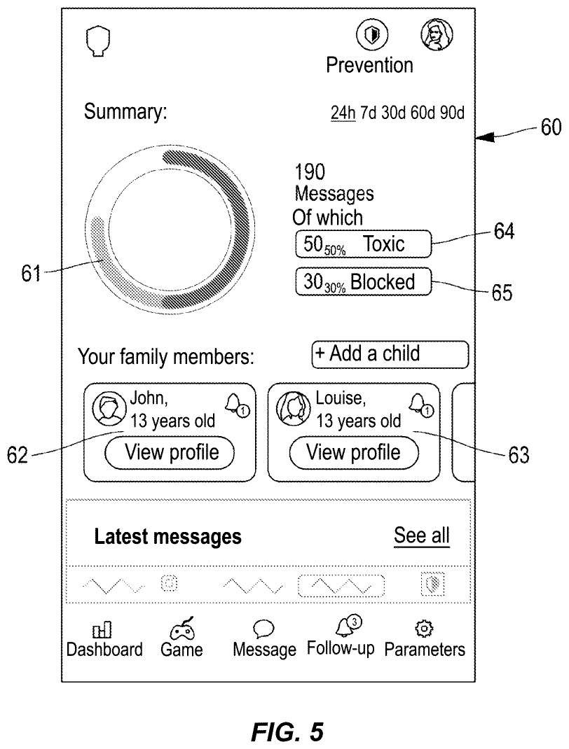

Referring to FIG. 5, the supervisor, for example, a parent or family member of legal age, can view a user interface 60 on which they can consult, for each of the protected users 62, 63 under their supervision, a summary 61 of the percentages of toxic and blocked messages 64, 65.

Each time a cyberbullying or toxic content situation is detected, the protected user—or their supervisor—will be able to view a “Defend me” user interface 70 on their smartphone, which offers a “Block” action 71 allowing the user sending the message to be blocked, and a “Pharos reporting” action 72 allowing a legal file to be built and a report to be output based on the detection information recorded by the protection method according to the present disclosure.

Of course, the present disclosure is not limited to the embodiment that has just been described, and many other embodiments can be envisaged without departing from the scope of the invention. In particular, the number of artificial brains employed in the protection method according to the present disclosure is not limited to that just described. In addition, the structure of the detection data to be written to the blockchain can be of any kind, depending on the effectiveness of the semantic and contextual analysis techniques employed. The same is true of the structure and practical content of the reporting logs.

1. A method for protecting a user of one or more social networks or video games against risks of cyberbullying, the user having a device connected to a communication network to access digital content from the one or more social networks or video games or to receive digital content from one or more other users of the one or more social networks or video games, the method comprising:
carrying out semantic and contextual analysis on the accessed or received digital content, employing artificial-intelligence techniques;
carrying out processing of the results of the semantic and contextual analysis to detect a cyberbullying situation or a toxicity of all or part of the content, employing a database of predetermined situations;
if a cyberbullying situation or a toxicity of digital content is detected, masking the display of the toxic digital content on the screen of the connected device;
wherein the method is implemented in a dedicated server suitable for being connected, via the communication network, to the social networks or video games;
and wherein the method further comprises, if a situation of cyberbullying or toxicity of digital content is detected, writing to a blockchain a set of data describing the cyberbullying, and wherein the semantic and contextual analysis implements a plurality of brains, each dedicated to a particular cyberbullying theme and operating simultaneously, each of the brains being intended to detect, after analysis, a word, a transcription of a voice message, an expression or an Emoji belonging to the theme associated therewith.

2. The method of claim 1, wherein the data describing cyberbullying or a toxicity of content is output in the form of a reporting log.

3. The protection method of claim 2, further comprising a prior check of the identity of the user to be protected, employing encryption of the identity data entered by the user from the connected device.

4. The protection method of claim 3, wherein the method employs decentralized software tools on the Web3.

5. The protection method of claim 4, further comprising accessing, from a second connected device, digital content received and detected as constituting cyberbullying or toxic content on a first connected device.

6. The protection method of claim 5, further comprising entering, from the connected device, a mention of one or more social networks or video game platforms on which protection is sought.

7. The protection method of claim 6, wherein the method is applied to participation in an online video game, wherein the semantic and contextual analysis and processing steps are further configured to detect a cheating situation in the video game.

8. A system for protecting a user of one or more social networks or video games against risks of cyberbullying, the user having a device connected to a communication network to access digital content from the one or more social networks or video games or to receive digital content from one or more other users of the one or more social networks or video games, employing the protection method according to claim 1, the system comprising:
means for carrying out semantic and contextual analysis on the accessed or received digital content, employing artificial-intelligence techniques;
means for processing the results of semantic and contextual analysis to detect a cyberbullying situation or a toxicity of all or part of the content, employing a database of predetermined situations; and
means for masking the display of toxic digital content on the screen of the connected device if a situation of cyberbullying or toxicity of digital content is detected;
wherein the system is implemented in a dedicated server suitable for being connected, via the communication network, to the video game social networks, and wherein the system further comprises means for writing to a blockchain a set of data describing this cyberbullying, and wherein the means for carrying out semantic and contextual analysis comprises a plurality of brains each dedicated to a particular cyberbullying theme and operating simultaneously, each of the brains being intended to detect, after analysis, a word, a transcription of a voice message, an expression or an Emoji belonging to the theme associated therewith.

9. The protection system of claim 8, wherein the system is implemented within a dedicated server communicating via one or more communication networks with one or more platforms operating social network services and with a plurality of connected devices accessing the social network services and for which protection against cyberbullying is sought.

10. The protection system of claim 9, further comprising means for sending a notification of detection of a cyberbullying situation to a dedicated platform.

11. The protection method of claim 1, further comprising a prior check of the identity of the user to be protected, employing encryption of the identity data entered by the user from the connected device.

12. The protection method of claim 1, wherein the method employs decentralized software tools on the Web3.

13. The protection method of claim 1, further comprising accessing, from a second connected device, digital content received and detected as constituting cyberbullying or toxic content on a first connected device.

14. The protection method of claim 1, further comprising entering, from the connected device, a mention of one or more social networks or video game platforms on which protection is sought.

15. The protection method of claim 1, wherein the method is applied to participation in an online video game, wherein the semantic and contextual analysis and processing steps are further configured to detect a cheating situation in the video game.
